(19) United States
(12) Patent Application Publication
(10) Pub. No.: US 2014/0193558 A1
(43) Pub. Date: Jul. 10, 2014

(54) MILK EMULSIFYING METHOD AND UNIT

(71) Applicant: Claudio Mosconi, Bergamo (IT)

(72) Inventor: Claudio Mosconi, Bergamo (IT)

(73) Assignee: N & W GLOBAL VENDING S.P.A, Valbrembo (IT)

(21) Appl. No.: 13/878,388

(22) PCT Filed: Oct. 6, 2011
(86) PCT No.: PCT/IB11/54412

§ 371 Date: Nov. 12, 2013

(30) Foreign Application Priority Data
Oct. 13, 2010 (IT) TO2010A000831

(51) Int. Cl. B01F 3/04; A23C 9/00

(52) U.S. Cl. CPC B01F 3/04787; A23C 9/00
USPC 426/474; 261/64.1; 261/42; 261/37

(57) ABSTRACT

A milk emulsifying method and unit, whereby a first flow of milk, fed along a first feed line (7) to an emulsifying chamber (5), draws a second flow of air from the outside along a second feed line (8) converging with the first feed line (7) upstream from the emulsifying chamber (5); the second flow being subjected to a repeat chopping operation, in which chopping is regulated in both frequency and duty cycle.

### TECHNICAL FIELD

The present invention relates to a milk emulsifying method and unit.

The present invention may be used to particular advantage for emulsifying milk in automatic or non-automatic infusion devices, for producing cappuccini or similar infusion beverages, and to which specific reference is made in the following description.

### BACKGROUND ART

Infusion devices of the above type normally employ milk emulsifying units of the type described, for example, in EP 1785074, which normally comprise a first milk feed line; a second air feed line; and a third steam feed line, which can be cut off by a valve to produce cold emulsified milk.

The three feed lines converge substantially independently, the first milk feed line always fully independent of the other two, inside an emulsifying chamber—normally a venturi chamber—which mixes the milk, air and steam (if any) to supply emulsified milk at the outlet, i.e. milk with a surface froth or ‘cream’, whose temperature and volume depend on the presence or absence of steam, the steam temperature, and the milk, air and steam ratio, which is controlled by regulating flow from a pump along the first line, and by regulating airflow along the second line by means of hydraulic resistors for regulating flow continuously or in pulses at adjustable frequency.

Though the amount of air, in the form of bubbles, in the emulsified milk is adjustable, known emulsifying units of the above type have the drawback of enabling practically no control over the ‘texture’, i.e. diameter, of the bubbles, which is what determines the stability of the froth produced, i.e. the smaller the bubbles, the more stable the froth is.

The emulsifying chamber being a venturi chamber, in which air is injected into the milk flow at such high speed as to allow absolutely no control over the emulsion produced, there is normally no way of predicting whether the air injected produces a large number of relatively small-diameter bubbles, or only a few large-diameter bubbles, and, in the event of the latter, whether the bubbles are broken up at the emulsifying chamber outlet.

### DISCLOSURE OF INVENTION

It is an object of the present invention to provide a milk emulsifying method and unit designed to eliminate the above drawbacks.

More specifically, it is an object of the present invention to provide a milk emulsifying method and unit designed to control the number and texture of the air bubbles in the emulsified milk produced.

According to the present invention, there is provided a milk emulsifying method as claimed in claim 1 and preferably in any one of the Claims depending directly or indirectly on claim 1.

According to the present invention, there is also provided a milk emulsifying unit as claimed in claim 7 and preferably in any one of the Claims depending directly or indirectly on claim 7.

### BRIEF DESCRIPTION OF THE DRAWINGS

A non-limiting embodiment of the present invention will be described by way of example with reference to the accompanying drawings, in which:

FIG. 1 shows a schematic of a preferred embodiment of the milk emulsifying unit according to the present invention;

FIG. 2 shows an operating diagram of a detail in FIG. 1.

### BEST MODE FOR CARRYING OUT THE INVENTION

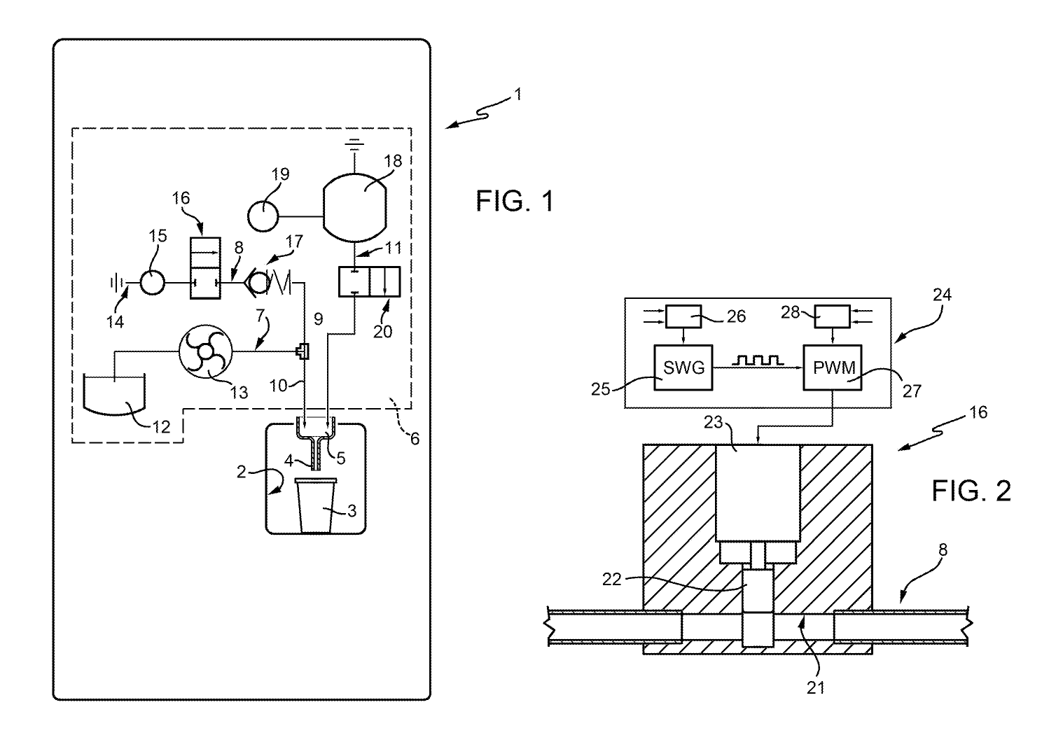

Number 1 in FIG. 1 indicates as a whole an infusion device comprising an externally accessible seat 2 for a removable cup 3 for receiving a beverage, e.g. a cappuccino, containing emulsified milk, and which, as the beverage is being made, is positioned beneath the outlet 4 of an emulsifying chamber 5—preferably a known venturi emulsifying chamber—of an emulsifying unit 6 of infusion device 1.

Emulsifying unit 6 comprises a milk feed line 7; an air feed line 8 communicating with feed line 7 at an intermediate ‘Y’ fitting 9, and having an end portion 10 in common with feed line 7 and terminating inside emulsifying chamber 5; and a steam feed line 11 terminating directly inside emulsifying chamber 5 and separate from feed lines 7 and 8.

Feed line 7 comprises a normally refrigerated tank 12, and extends from tank 12 to intermediate fitting 9 via a pump 13—normally, though not necessarily, a gear pump.

Feed line 8 has an inlet 14 communicating with the outside, and extends from inlet 14 to intermediate fitting 9 via, and in the order shown: an optional air filter 15; a valve assembly 16 for controlling airflow along feed line 8; and an optional calibrated non-return valve 17, which permits airflow to intermediate fitting 9, but under no circumstances permits backflow of milk to valve assembly 16 via intermediate fitting 9.

Feed line 11 comprises a boiler 18 supplied with water from a source (not shown), such as the water mains, and which feeds steam to emulsifying chamber 5 via an electrically actuated shut-off valve 20 and at a given temperature controlled by a thermostat unit 19 and preferably on the basis of the milk temperature recorded by a sensor (not shown) at intermediate fitting 9.

As shown in FIG. 2, valve assembly 16 is a repeat chopping type, and comprises a passage 21 defining a portion of feed line 8; a preferably electrically actuated shutter 22 movable through passage 21 between an open position and a closed position opening and closing passage 21 respectively; a normally electromagnetic or piezoelectric actuator 23 for activating shutter 22; and a repeat chopping unit RCU 24 implemented by an electronic control system designed, among other things, to supply adequate power to control electromagnetic actuator 23.

Schematically, RCU 24 comprises a square wave generator SWG 25 for producing a train of square waves, the frequency of which is regulated by a control circuit on the basis of a given number of partly set and partly recorded quantities (e.g. a given range; an external temperature; beverage characteristics dictated by average consumer preference in the country in which infusion device 1 is operated, etc.); and a pulse width modulator PWM 27 for regulating the duty cycle, i.e. activation time within each pulse, and which is controlled by a control circuit 28 on the basis of a given number of other partly set and partly recorded quantities (e.g. a given range; steam temperature; the temperature inside cup 3, etc.).

RCU 24 is preferably implemented in a PLC or, in general, in an integrated or distributed electronic control system designed to receive and process recorded quantities, calculate the necessary frequency and duty cycle, and supply the necessary power to actuator 23.

Valve assembly 16 is a commercial type, has a very fast response time (in the order of a thousandth of a second), and is used in emulsifying unit 6 to break up or ‘chop’ the continuous airflow drawn through inlet 14 into a succession of ‘segments’, each defining an air bubble on entering the milk flow at intermediate fitting 9.

Because air is drawn from the outside by the low pressure produced along feed line 8, just upstream from intermediate fitting 9, the air ‘segments’ moving along feed line 8 to intermediate fitting 9 all travel at the same speed, like the peaks of a single pressure wave modulated by valve assembly 16, remain separate, and penetrate the milk flow from feed line 7 without compacting, i.e. still remaining separate, on account of the substantially zero relative speed at which the air ‘segments’ enter the milk flow.

In other words, because of the presence of valve assembly 16, pre-emulsification occurs along shared end portion 10, so that what flows out of shared end portion 10 is a highly stable mixture of milk and dispersed air bubbles.

In emulsifying unit 6, RCU 24 serves to adjust the size and number of these air bubbles, and so adjust both the amount and texture of the froth produced, without having to intervene on the cross sectional size of passage 21, which may thus be made large enough to reduce cleaning, which can be further reduced using air filter 15.

The number of air bubbles produced can be adjusted by adjusting the frequency of the square waves controlling actuator 23 by means of SWG 25; and the size, i.e. ‘texture’, of the air bubbles can be adjusted by adjusting the length of the duty cycle, i.e. the opening time of shutter 22, by means of PWM 27.

In other words, regulating the frequency and duration of the activating pulse of shutter 22 by means of PWM 27 provides for both dynamic ‘mean adjustment’ and choking of the airflow to achieve optimum quantity and size of the air bubbles in the emulsion.

Bubble size being strongly affected by beverage temperature, electrically actuated valve 20 is kept closed to produce cold emulsified milk, and the above adjustments preferably also take ambient temperature into account; and, conversely, to produce hot emulsified milk, electrically actuated valve 20 is kept open, and the above adjustments preferably also take into account the temperature setting of thermostat unit 19.

Valve assembly 16 may obviously be kept closed to produce a flat beverage, though this operating mode is outside the scope of the technical problem dealt with herein, and is included solely for the sake of thoroughness.

1-18. (canceled)

19. A milk emulsifying method, comprising:
feeding a first flow of milk along a first feed line to an emulsifying chamber; and
pre-emulsifying the milk with air, upstream from the emulsifying chamber, by drawing a second flow of air, by the first flow, along a second feed line converging with the first feed line along a pre-emulsifying end portion upstream from the emulsifying chamber;
wherein the second flow is subjected, at a point along the second feed line and upstream from the pre-emulsifying end portion to a repeat chopping operation in which chopping is regulated in both frequency and duty cycle.

20. The milk emulsifying method as claimed in claim 18, wherein the second flow is drawn from the outside and, upstream from the point along the second feed line, is substantially continuous.

21. The milk emulsifying method as claimed in claim 18, wherein the second flow is filtered upstream from the point along the second feed line.

22. The milk emulsifying method as claimed in claim 18, wherein the repeat chopping operation is performed by a valve assembly located at the point along the second feed line, and including an electrically actuated shutter controlled by a repeat chopping unit.

23. The milk emulsifying method as claimed in claim 22, wherein the repeat chopping operation is regulated in frequency and duty cycle by controlling the electrically actuated shutter by a train of generally square waves of adjustable given frequency that are emitted by a square wave generator, and by adjustably modulating the train of generally square waves by a pulse width modulator.

24. The milk emulsifying method as claimed in claim 18, wherein the first flow is forced by a pump.

25. A milk emulsifying unit, comprising:
an emulsifying chamber;
a first feed line for feeding a first flow of milk to the emulsifying chamber;
a second feed line converging with the first feed line along a shared end portion upstream from the emulsifying chamber, the second feed line for feeding a second flow of air to the shared end portion, and for feeding a pre-emulsified flow of milk and air to the emulsifying chamber; and
a valve assembly located at a point along the second feed line and upstream from the shared end portion, the valve assembly including an electrically actuated shutter movable between an open position and a closed position for opening and closing the second feed line respectively, and a repeat chopping unit for controlling the electrically actuated shutter in frequency and duty cycle.

26. The milk emulsifying unit as claimed in claim 25, wherein the repeat chopping unit includes a square wave generator and a pulse width modulator, both of which are integrated with the repeat chopping unit; wherein the square wave generator is configured to emit a train of square waves at a given adjustable frequency; and wherein the pulse width modulator is interposed between the square wave generator and the electrically actuated shutter, and configured to receive and adjustably modulate the train of square waves to control the electrically actuated shutter in frequency and duty cycle.

27. The milk emulsifying unit as claimed in claim 25, wherein the repeat chopping unit is implemented in a PLC, an integrated electronic control system, or a distributed electronic control system for receiving and processing recorded quantities, calculating the necessary frequency and duty cycle, and supplying the necessary power to activate the electrically actuated shutter.

28. The milk emulsifying unit as claimed in claim 26, wherein the repeat chopping unit includes control means for controlling the frequency of the square wave generator on the basis of a given number of partly set and partly recorded quantities.

29. The milk emulsifying unit as claimed in claim 26, wherein the repeat chopping unit includes control means connected to the pulse width modulator to control the duty cycle of the electrically actuated shutter on the basis of a given number of partly set and partly recorded quantities.

30. The milk emulsifying unit as claimed in claim 25, wherein the second feed line has an inlet communicating with the outside.

31. The milk emulsifying unit as claimed in claim 25, further comprising an air filter located along the second feed line, upstream from the valve assembly.

32. The milk emulsifying unit as claimed in claim 25, further comprising a non-return valve located along the second feed line, downstream from the valve assembly.

33. The milk emulsifying unit as claimed in claim 25, wherein the first feed line comprises a milk pump.

34. The milk emulsifying unit as claimed in claim 25, further comprising a third feed line independent of the first feed line and the second feed line, and for feeding steam to the emulsifying chamber.

35. The milk emulsifying unit as claimed in claim 34, wherein the emulsifying chamber is a venturi emulsifying chamber.

36. An infusion device for producing infused beverages, the infusion device comprising the milk emulsifying unit as claimed in claim 25.
